(19) United States
(12) Patent Application Publication
(10) Pub. No.: US 2025/0348553 A1
(43) Pub. Date: Nov. 13, 2025

(54) SINGLE CYCLE BINARY MATRIX MULTIPLICATION

(71) Applicant: GSI Technology, Inc., Sunnyvale, CA (US)

(72) Inventors: Avidan Akerib, Tel Aviv (IL); Eli Ehrman, Beit Shemesh (IL); Bob Haig, Sunnyvale, CA (US); Lee-Lean Shu, Sunnyvale, CA (US)

(21) Appl. No.: 19/200,384

(22) Filed: May 6, 2025

Related U.S. Application Data
(60) Provisional application No. 63/644,409, filed on May 8, 2024.
(60) Provisional application No. 63/644,399, filed on May 8, 2024.

(51) Int. Cl. G06F 17/16

(52) U.S. Cl. CPC G06F 17/16

(57) ABSTRACT

A system and method for single cycle binary matrix multiplication in neural network computations is disclosed. The system includes a memory array storing binary weights, an input unit for activating rows based on a binary activation vector, and per-column majority sense amplifiers. The system performs binary matrix multiplication in a single cycle, enabling efficient implementation of binary neural networks. The memory array may include sections for weights and inverse weights, with corresponding activation register sections. Differential sense amplifiers may implement the majority function. The system can be applied to convolutional neural networks, using SRAM arrays for image storage and processing. Methods for determining majority votes and counting activated bits using iterative modification of the activation vector are also described.

### CROSS REFERENCE TO RELATED APPLICATIONS

This application claims priority from U.S. provisional patent applications 63/644,399 and 63/644,409, both filed May 8, 2024, both of which are incorporated herein by reference.

### FIELD OF THE INVENTION

The present invention relates generally to systems and methods for single cycle binary matrix multiplication in multiple applications in general and in neural network computations in particular.

### BACKGROUND OF THE INVENTION

In the field of neural networks and machine learning, efficient computation of matrix multiplication is crucial for performance. FIG. 1 illustrates a typical neural network structure, comprising an input layer, a hidden layer, and an output layer. The input layer contains nodes A0, A1, and A2, while the hidden layer consists of nodes B0 through B4, and the output layer includes nodes C0, C1, and C3. These layers are interconnected through weighted connections, such as WA00, WA10, and WA20 between the input and hidden layers, and WB00, WB24, and WB42 between the hidden and output layers.

The core operation in neural networks involves the multiplication of input values with their corresponding weights, followed by summation and activation. This process essentially translates to a series of matrix multiplications. As neural networks grow in size and complexity, the efficiency of these matrix operations becomes increasingly critical.

FIG. 2 depicts a block diagram of a conventional multiply-accumulate architecture 10 commonly used in neural network computations. This architecture includes a weights memory 12 connected to a multiplier and accumulator 14. The multiplier and accumulator 14 receives activation values as input and produces output that is stored in an output register. This traditional approach typically involves a multi-step process that separates data storage from computation.

The conventional process begins with storing floating point weights in memory 12. These weights are then loaded from memory 12 to multiplier and accumulator 14, which also receives activation values. The system performs floating point multiplication and accumulation operations on the loaded weights and activation values. Finally, the output is produced and is often stored in a different memory unit. This process often requires multiple clock cycles and significant data movement between memory and processing units.

Each step in this conventional approach introduces latency and consumes energy, particularly the repeated reading from and writing to memory. As neural networks continue to expand in scale and intricacy, these limitations become increasingly pronounced, affecting the overall performance and scalability of machine learning systems. The data movement between storage and computation elements becomes a bottleneck, limiting both the speed of computation and energy efficiency.

The data movement is reduced in an associative processing unit (APU), such as the ones commercially available from GSI Technologies Inc. of the USA, since APUs perform in-memory processing and GSI's include the ability to implement an in-memory multiply-accumulator (MAC).

Reference is now made to FIG. 3, which illustrates an exemplary in-memory MAC 100. MAC 100 comprises a controller 116, a memory array 110, and a multiply-accumulator unit that includes a multi-bit multiplier 112 and a multi-bit layered adder 114. Memory array 110 has word lines 111 activating rows of cells and bit lines 118 connecting columns of cells. In addition, memory array 110 is divided into sections 113. Memory array 110 stores a plurality of multi-bit words, each one in a separate column with each bit of the word stored in a separate section, and with the words aligned. Thus, when controller 116 activates a word line 111, it activates the same bit of each multi-bit word at the same time.

For in-memory operations, controller 116 activates multiple rows at a time, such that, for example, the row storing bit i of multiple variables Aj and the row storing bit i of multiple variables kj may be activated at the same time.

Each column 118 in each section 113 implements a bit line processor (BLP). The ith bit line processor may operate on its associated pair of input values Ai and ki when their rows are activated. Exemplary bit line processors are described in U.S. Pat. No. 9,418,719 entitled “In-Memory Computational Device”, assigned to Applicant and incorporated herein by reference. The output of each bit line processor is read by a per-column sense amplifier 120.

In accordance with a preferred embodiment of the present invention, controller 116 may activate the rows of memory array 110 to implement multi-bit multiplier 112 such that each bit line processor 118 may perform the multiplication operation on its associated pair of input values Ai and ki to produce a multiplication result Aiki. An exemplary associative multiplication operation is described in U.S. Pat. No. 10,635,397, entitled “System and Method for Long Addition and Long Multiplication in Associative Memory”, assigned to the Applicant and incorporated herein by reference.

In accordance with a preferred embodiment of the present invention, controller 116 may activate the rows of memory array 110 to implement multi-bit layered adder 114 to add together the multiplications from the multiple bit line processors along bit lines 118. An exemplary 4 cycle full adder is described in U.S. Pat. No. 10,534,836, assigned to Applicant and incorporated herein by reference.

### SUMMARY OF THE PRESENT INVENTION

There is therefore provided, in accordance with a preferred embodiment of the present invention, an in-memory, one cycle, binary multiplier. The binary multiplier includes a memory array, an input unit and a plurality of majority sense amplifiers, one per column of the weights matrix. The memory array has rows and columns and stores a weights matrix of binary weights therein. The input unit receives a binary activation vector and activates rows of the weight matrix according to the binary activation vector. Each majority sense amplifier generates a majority function of the multiplication of the binary weights in its column by the binary activation vector.

Moreover, in accordance with a preferred embodiment of the present invention, the weights matrix includes a positive section and an inverse section storing the binary weights and inverses of the binary weights respectively. The binary activation vector includes a positive portion and an inverse portion storing the binary activations and inverses of the binary activations, respectively. The columns of the positive section are aligned with columns of the inverse section and the input unit activates rows of the positive section according to the positive portion and rows of the inverse section according to the inverse portion.

Further, in accordance with a preferred embodiment of the present invention, the memory array includes a plurality of SRAM cells each storing a binary weight, where each the SRAM cell is activatable by a positive word line and an inverse word line and provides results of a binary multiplication of the binary weight with a positive word line value on a positive bit line and results of a binary multiplication of the binary weight with an inverse word line value on an inverse bit line, and a plurality of per-column majority units to determine a majority value of the positive and inverse outputs of a column of the plurality of SRAM cells.

Still further, in accordance with a preferred embodiment of the present invention, the per-column majority units are differential sense amplifiers.

Additionally, in accordance with a preferred embodiment of the present invention, the weights matrix stores ternary weights encoded using pairs of binary bits, where a ternary value of +1 is represented by [1,0], a ternary value of −1 is represented by [0,1], and a ternary value of 0 is represented by [0,0]. The binary activation vector includes ternary activation values encoded using pairs of binary bits, the input unit activates rows of the weight matrix according to the ternary activation values, and each majority sense amplifier generates a majority function of the multiplication of the ternary weights in its column by the ternary activation vector.

Moreover, in accordance with a preferred embodiment of the present invention, the binary multiplier also includes a controller. The controller provides an initial binary activation vector to the input unit to generate an initial majority result using the plurality of majority sense amplifiers, modifies the binary activation vector by adding or removing one or more bits, provides the modified binary activation vector to the input unit to generate a subsequent majority result using the plurality of majority sense amplifiers, compares the initial majority result with the subsequent majority result, and determines a characteristic of the majority vote based on the comparison.

Further, in accordance with a preferred embodiment of the present invention, the controller provides an initial binary activation vector to the input unit to generate an initial majority result using the plurality of majority sense amplifiers, iteratively modifies the binary activation vector by adding or removing a predetermined number of bits, provides each modified binary activation vector to the input unit to generate subsequent majority results using the plurality of majority sense amplifiers, compares each subsequent majority result with previous majority results, and determines a count of activated bits in the initial binary activation vector based on the comparisons.

There is therefore provided, in accordance with a preferred embodiment of the present invention, a system for implementing a multi-layer neural network. The system includes a memory array, an activation register, a controller, and an output register. The memory array includes a plurality of columns, each column storing a plurality of binary weights and having a bit line processor. The activation register is configured to store activation values. The controller is configured to iteratively, for each layer of the neural network: activate multiple rows of the memory array according to a vector of binary activation values for a current cycle to multiply columns of the memory array by the vector of binary activation values, in per-column majority sense amplifiers corresponding to a subset of columns of the memory array corresponding to weights between the current layer and a next layer, output per-column majority values for the subset of columns, as the values for the next layer, update the activation register with the generated output values for use as activation values in processing a next layer in a next cycle. The output register is configured to receive output values generated for a final layer of the multi-layer neural network.

Moreover, in accordance with a preferred embodiment of the present invention, the per-column majority sense amplifiers are differential sense amplifiers.

Further, in accordance with a preferred embodiment of the present invention, the memory array includes a plurality of SRAM cells each storing a binary weight, where each SRAM cell is activatable by a positive word line and an inverse word line and provides results of a binary multiplication of the binary weight with a positive word line value on a positive bit line and results of a binary multiplication of the binary weight with an inverse word line value on an inverse bit line.

Still further, in accordance with a preferred embodiment of the present invention, the system is configured to implement a convolutional neural network (CNN) and also includes a storage memory array to store image data and to provide an operatable portion of the image data to the activation register.

There is therefore provided, in accordance with a preferred embodiment of the present invention, a binary neural search system. The system includes a memory array, a binary key unit, a plurality of unbalanced sense amplifiers, and a controller. The memory array includes a plurality of columns, each column storing a binary vector of a binary database. The binary key unit is configured to receive a binary search term. The plurality of unbalanced sense amplifiers, each unbalanced sense amplifier corresponding to a column of the memory array. The controller is configured to activate multiple rows of the memory array according to the binary search term, thereby causing a parallel match operation between the search term and each binary vector stored in the columns of the memory array, and determine, from the output of the unbalanced sense amplifiers, matches between the search term and one or more binary vectors in the binary database based on a number of matching bits for the one or more binary vectors, where each unbalanced sense amplifier is configured to output a match indication only when the number of matching bits in its corresponding column exceeds a predetermined threshold.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 is a schematic illustration of a prior art neural network architecture;

FIG. 2 is a block diagram illustration of a prior art multiply accumulate architecture;

FIG. 3 is a block diagram illustration of a prior art multiply-accumulator system;

FIG. 4 is a schematic illustration of a system diagram showing transformation between neural network representations, constructed and operative according to an embodiment of the present invention;

FIGS. 5A-5B are schematic illustrations of two inventive types of in-memory multiplication using a majority function, constructed and operative according to an embodiment of the present invention;

FIG. 6 is a schematic illustration of one implementation of the single cycle, binary matrix multiplication of FIG. 5B;

FIG. 7 is a block diagram illustration of a majority system which uses SRAM memory cells, constructed and operative according to an embodiment of the present invention;

FIG. 8 is a schematic illustration of a neural network architecture and its implementation with the majority system of FIG. 7, constructed and operative according to an embodiment of the present invention;

FIG. 9 is a schematic illustration of an alternative binary neural network implementation using an associative processing unit for a convolution neural network (CNN);

FIG. 10 is a schematic illustration of an implementation for ternary bits, constructed and operative according to an alternative embodiment of the present invention; and

FIG. 11 is a system diagram illustration of a binary neural search system, constructed and operative according to an embodiment of the present invention.

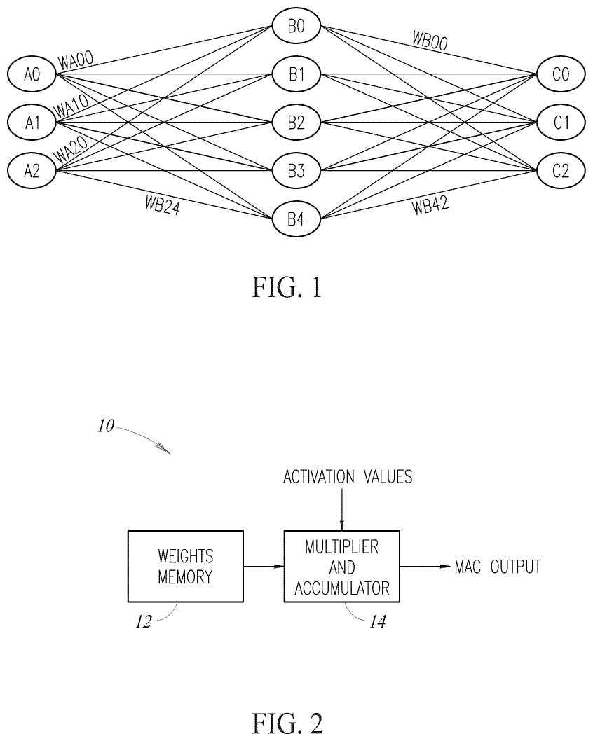

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

Applicant has realized that binary data, represented by values of 1 or −1, requires significantly less memory storage compared to floating-point representations. Additionally, binary operations consume less computational power than their floating-point counterparts.

Consequently, the Applicant has realized that binary neural networks, which use binary weights and activations, offer substantial advantages in terms of power consumption and computational efficiency. This makes them particularly suitable for resource-constrained environments and applications requiring low-power operation. Crucially, Applicant has realized that the core operation of binary neural networks (i.e. binary matrix multiplication) can be performed in a single cycle, dramatically reducing latency and energy consumption compared to traditional multi-cycle approaches.

Applicant has further realized that, despite their simplified representation, binary neural networks can achieve high levels of accuracy when properly trained. Since the network uses binary values during the training process, it learns to make effective use of the limited representational capacity, resulting in a model that maintains accuracy while benefiting from the efficiency of single cycle binary operations. This single cycle operation forms the foundation of the binary neural network's efficiency.

Furthermore, Applicant has realized that the multiply-accumulate operation for binary matrix multiplication can be performed in a single cycle using a majority function operation. Applicant has realized that the single cycle binary matrix multiplication operation is particularly beneficial for binary neural networks and similar applications.

Moreover, Applicant has realized that this single cycle binary matrix multiplication is simple to implement in an associative processing unit (APU), such as the ones commercially available from GSI Technologies Inc. of the USA, which is ideal for Boolean or binary operations.

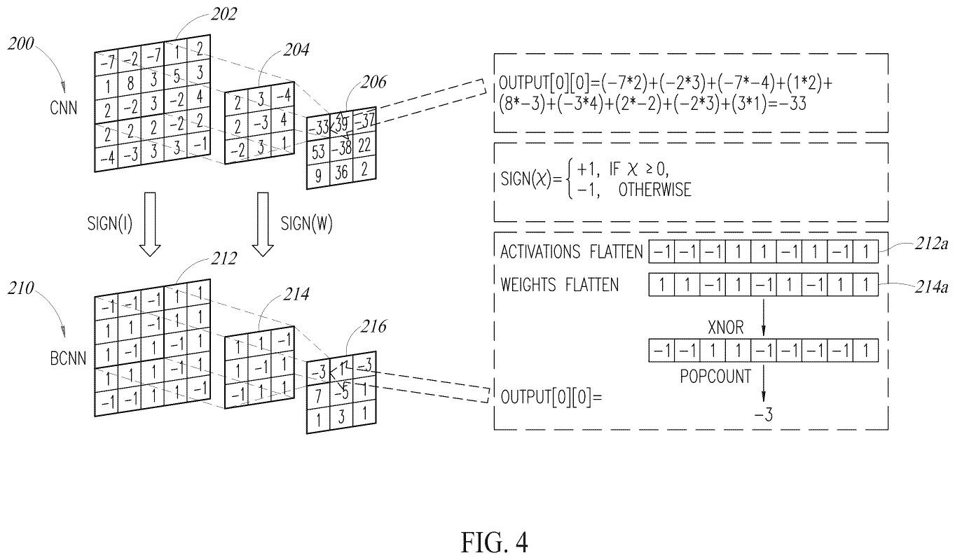

Reference is now made to FIG. 4, which illustrates the conversion from a Convolutional Neural Network (CNN), shown in a CNN portion 200, to a Binary Convolutional Neural Network (BCNN), shown in a BCNN portion 210. As is known, convolutional neural networks typically operate on images and convolve a section of the image with a 2-dimensional filter of some kind to generate a derived image having desired properties. For example, the 2-dimensional filter may be a low or high pass filter or an averaging filter. In neural networks, the filter is known as a weight matrix.

In FIG. 4, CNN portion 200 comprises a 5×5 CNN activation matrix 202 and the 2-dimensional filter is an averaging filter implemented as a 3×3 CNN weight matrix 204. Each 3×3 portion of activation matrix 202 is multiplied by 3×3 CNN weight matrix 204 according to standard multiplication operations, where FIG. 4 shows the operation for the (0,0) value of CNN activation matrix 202. The result is a CNN output matrix 206, where the (0,0) value, as per the equation shown, is-33.

To convert floating point operations to binary operations, each of the values of both the CNN activation matrix 202 and the CNN weight matrix 204 are first converted to binary values as a function of the sign of the floating point value, where the binary value is set to +1 if the floating point value is positive and the binary value is set to-1 if the floating point value is 0 or negative, as shown. This produces a BCNN activation matrix 212 and a BCNN weight matrix 214 which, when multiplied in a binary manner, produce a BCNN output matrix 216.

It will be appreciated that both the 3×3 portion of the binary activation matrix 212 and the 3×3 binary weight matrix 214 may be ‘flattened’ such that they may be implemented as row vectors 212a and 214b, as shown.

Given that all of the data is binary, the BCNN requires only XNOR operations to implement the multiplication operation, along with a popcount operation for the accumulation operation of the multiplication. Thus, the popcount for the (0,0) value is −3.

However, conventional implementations of BCNNs still typically involve separate memory and processing units, requiring data movement between storage and computation elements, and in-memory implementation of BCNNs requires providing row vectors, such as 212a and 214b, for in-memory multiplication.

Applicant has realized that, for binary multiplications, the multiply-accumulate operation may be significantly simplified since a binary multiplication may be implemented simply as a NXOR operation. Applicant has realized that, rather than storing both the weights and the activations in rows of memory 110 and then implementing the NXOR operation, only the weights need to be stored while the activations may be used to instruct the activation of the rows. Furthermore, since the output of a binary multiplication for a neural network needs only to be a binary number, the sum of the NXOR operation may be implemented with a majority operation. As mentioned hereinabove, Applicant has realized that such a multiply-accumulate operation with a majority function may be performed in a single cycle.

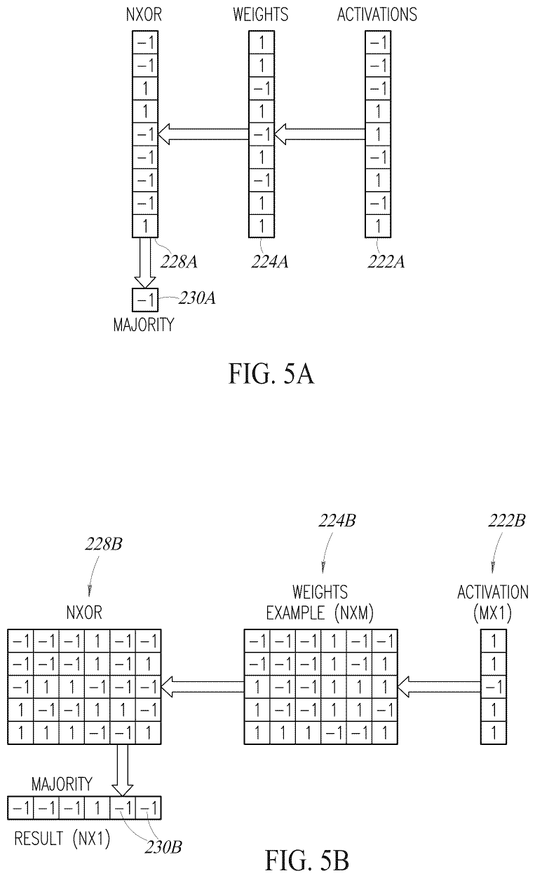

Reference is now made to FIGS. 5A and 5B, which generally demonstrate two inventive types of in-memory multiplication using a majority function, where FIG. 5A shows the multiplication operation for the BCNN of FIG. 4 and FIG. 5B shows the multiplication operation for a deep neural network (DNN), discussed in more detail hereinbelow. In this embodiment, the APU stores the binary weights in its weight memory 224 and activates the rows of weight memory 224 according to an activation register 222 storing the activation values. In FIG. 5A, there is a single column 224A of weights, implementing the flattened activations of FIG. 4, while in FIG. 5B, there are multiple columns 224B of weights.

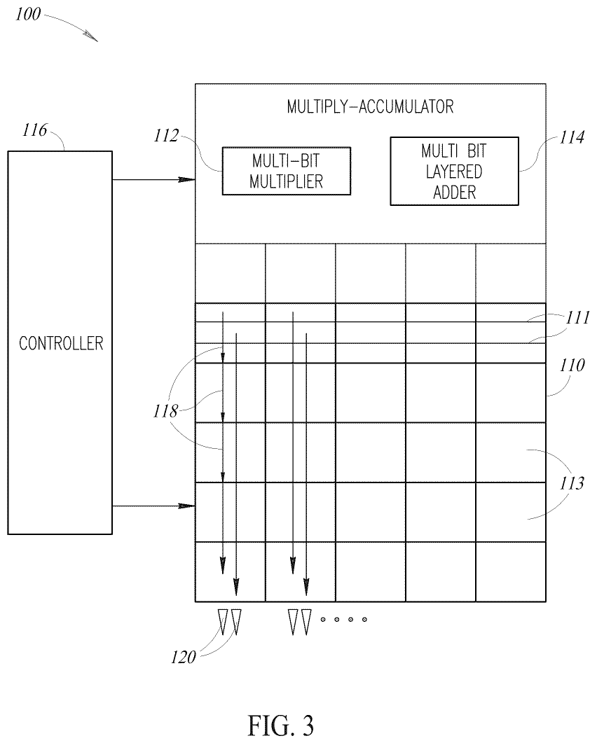

When a controller, similar to controller 116 of FIG. 3, activates the rows according to the binary activation values, an NXOR operation, which is equivalent to a binary multiplication, automatically occurs in the rows as a result of the activation of the weights. Thus, the activation value of each row is NXOR'd with each of the binary weights in that row. In FIG. 5A, this produces a single NXOR column 228A while in FIG. 5B, this produces an NXOR matrix 228B.

Since, in an APU, all the rows may be activated at the same time, the per column bit line processors on NXOR 228A or 228B would sum all of the NXOR values in their column, to be read by a standard sense amplifier. The result is generally not a binary number. However, as mentioned hereinabove, since a binary multiplication for a neural network needs only to be a binary number, the sum of each NXOR operation may be implemented by a majority unit, indicated at 230A in FIGS. 5A and 230B in FIG. 5B. For example, per-column majority units 230A or 230B may be implemented with two standard memory cells operating as a differential sense amplifier.

It will be appreciated that FIGS. 5A and 5B illustrate two embodiments of in-memory, single cycle, binary multipliers, which may be used for a binary neural network. It will further be appreciated that single cycle multipliers allow for extremely fast and energy-efficient binary matrix multiplication, which is particularly beneficial for binary neural networks and similar applications.

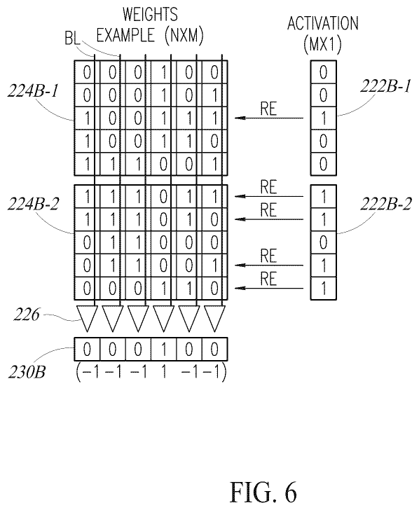

Reference is now made to FIG. 6, which illustrates one implementation of the single cycle, binary matrix multiplication of FIG. 5B. Note that in FIGS. 5A and 5B, the data is shown as +1 or −1 when, in general, memory cells store +1 or 0. Thus, for this embodiment, O values are shown, indicating the logical −1 values.

In this embodiment, the memory array stores the binary weights of FIG. 5B in a first portion 224B-1 of the memory array and their inverses in a second portion 224B-2 of the memory. Thus, the first row of second portion 224B-2 stores the inverse weights of the first row of first portion 224B-1. Moreover, the columns of the two portions 224B-1 and 224B-2 are aligned, such that the first column of first portion 224B-1 extends into the first column of second portion 224B-2.

In this embodiment, the read enable (RE) lines, which activate the word lines of weight memory 224B, are controlled by activation register 222B, such that first portion 224B-1 of binary weights may be activated by a first section 222B-1 of activation values and second portion 224B-2 of inverse weights may be activated by a second section 222B-2 of inverse activation values, effectively performing XNOR operations between activations and weights, and between inverse activations and inverse weights. Note that, as shown, the read enable lines are only active for positive activation values, for which there is one positive activation value in first activation portion 222B-1 (corresponding to the only +1 value in activation column 222 of FIG. 5B) and four positive activation values in second activation portion 22B-2 (corresponding to the −1 values in activation column 222 of FIG. 5B).

It will be appreciated that the output of these activations will be provided on the bit lines (BL) extending through weight memory array sections 224B-1 and 224B-2, which are then read by sense amplifiers 226.

In this embodiment, sense amplifiers 226 may be differential sense amplifiers, such as the differential sense amplifier described in U.S. Pat. No. 7,965,564 to Lavi, et al, assigned to Applicant and incorporated herein by reference, and, as a result, each one may perform an inverse majority operation on the data on its bit line. In other words, the differential sense amplifiers may indicate if the data of the column is more positive (i.e. a logical +1 value) or more negative (i.e. a logical −1 value), where, for the inverse majority operation, the differential sense amplifiers produce a 1 value if the number of 1 s is less than the number of zeros, and a 0 value otherwise. The results of this cycle may be written into an output register 230B, effectively performing the multiply-accumulate operation in a single cycle, directly within the memory array storing weight memory 224. In FIG. 6, the values of output register 230B are listed as 0's and 1's with their logical −1 and +1 values listed in parentheses.

It will be appreciated that each per-column sense amplifier may perform a majority function of the multiplication of said binary weights in its column by said binary activation vector.

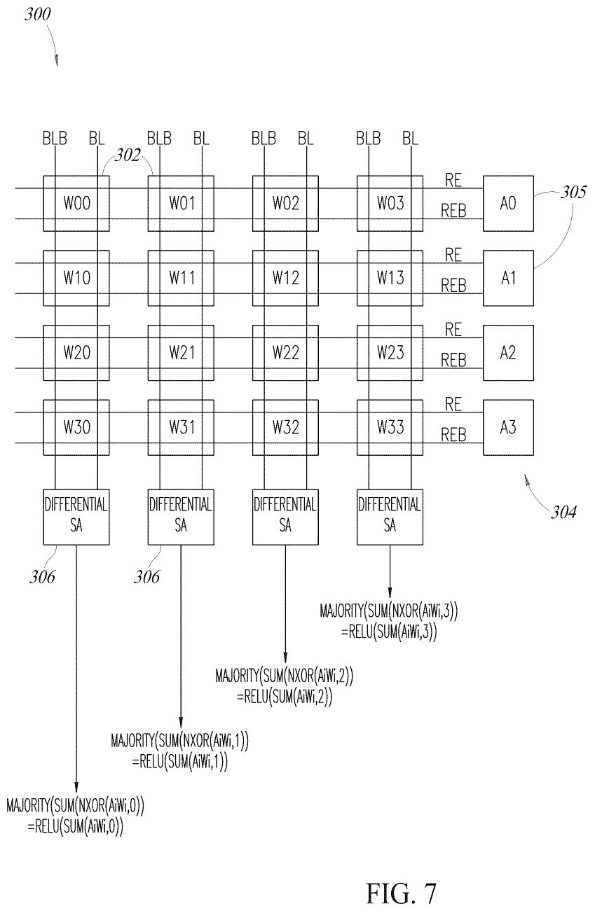

Reference is now made to FIG. 7, which illustrates an alternative majority system 300 which uses SRAM memory cells 302 in an exemplary 14-transistor (14T) configuration, described in U.S. provisional patent application 63/644,409 and in U.S. patent application Ser. No. 19/199,980, filed concurrently herewith, commonly owned by Applicant and incorporated herein by reference. In this embodiment, each memory cell 302 may store a binary weight Wij, an activation register 304 may store binary activation values Aj in its activation cells 305, and differential sense amplifiers 306 may implement majority units 230.

Each memory cell 302 storing weight Wij may allow simultaneous access from two word lines, a first one RE which may provide the input activation value Aj from its associated activation cell 305 and a second one REB which may provide the inverse activation value-Aj from its associated activation cell 305 (i.e. the inverse word line REB may include an inverter). It will be appreciated that, in this embodiment, only a single set of activations Aj are stored.

Each memory cell 302 may provide output along two bit lines, one labeled BL, and one labeled BLB, where bit line BL may provide the multiplication of the stored weight Wij with the input activation value Aj, and inverse bit line BLB may provide the inverse multiplication of the inverse-Wij of the stored weight with the inverse-Aj of the input activation. The two bit lines may provide their output to their associated per-column differential sense amplifier 306.

Thus, each memory cell 302 may provide both its weight and its inverse weight and each cell of activation register 304 may provide both its activation value and its inverse activation value. Note that, as discussed hereinabove, the read enable lines are only active for positive activation values.

Since each memory cell 302 may provide the positive and inverse multiplication results, one bit line processor may produce the sum of the NXORs and the other bit line processor may produce the sum of the inverse of the NXORs. It will be appreciated that therefore, each per-bit line majority unit 306 needs only to be a differential sense amplifier to perform a majority voting operation between its bit line and its inverse bit line.

Moreover, it will be appreciated that the majority operation of FIG. 7 may be performed in a single cycle.

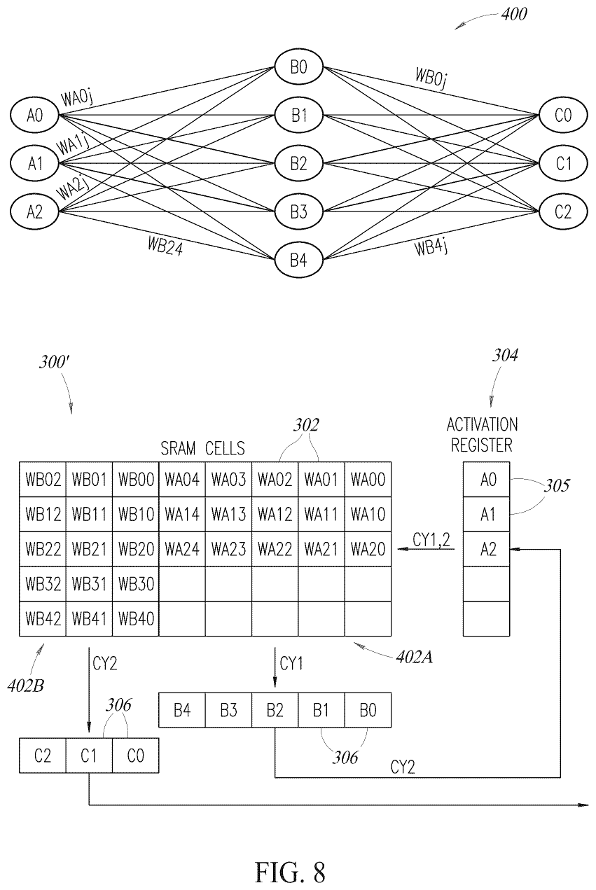

Reference is now made to FIG. 8, which illustrates a Deep Neural Network (DNN) architecture 400 and its associated memory implementation using system 300 of FIG. 7, here labeled 300′. For exemplary purposes, network 400 may be a simple network comprising only three layers: an input layer with binary nodes A0, A1, and A2; a middle layer with binary nodes B0, B1, B2, B3, and B4; and an output layer with binary nodes C0, C1, C2, and C3.

The network connections between layers may be implemented through weight matrices. The input layer may connect to the middle layer through weights WA0j, WA1j, and WA2j, while the middle layer may connect to the output layer through weights WB0j, WB1j, WB2j, WB3j and WB4j.

For system 300′, SRAM cells 302 may be organized in two sections, a first one 402A for the connection from the input layer (i.e. input nodes Aj) to the middle layer (i.e. middle nodes Bj), and a second one 402B for the connection from the middle layer to the output layer (i.e. nodes Cj). First section 402A may store the 3×5 weight matrix cells WA00-WA04, WA10-WA14, WA20-WA24 and second section 402B may store the 4×3 weight matrix cells WB00-WB02, WB10-WB12, WB20-WB22, WB30-WB32, WB40-WB42.

In a first cycle CY1, a controller (not shown) of system 300′ may use the 3 activation cells A0-A2 as input to the input layer and, accordingly, may activate the columns of first section 402A according to the activation values A0-A2 and their inverses, as discussed hereinabove, thereby to multiply the 3×5 weight matrix cells WA00-WA04, WA10-WA14, WA20-WA24 by the activation values A0-A2. Per-column differential sense amplifiers 306 of first section 402A may produce the first majority results B0-B4.

In a second cycle CY2, the controller of system 300′ may write the first cycle results B0-B4 into activation register 304, writing over input activations A0-A2 with the first cycle results B0-B4, where the first result B0 may be written into the first register, writing over input activation A0, etc. The controller may then use second cycle activation values B0-B4 as input to middle layer and, accordingly, may activate the columns of second section 402B according to the activation values B0-B4 (and their inverses), thereby multiplying the 5×3 weight matrix cells WB00-WB02, WB10-WB12, WB20-WB22, WB30-WB32, WB40-WB42 by second cycle activation values B0-B4. Per-column differential sense amplifiers 306 of second section 402B may produce the second majority results C0-C2.

In a third cycle CY3, the controller may provide the second cycle majority results C0-C2 as the output of this simple example network.

It will be appreciated that the output of each layer (which is the output of each cycle) is immediately available to serve as the input for the subsequent layer, by writing the output directly into activation register 304, ready for the next cycle.

It will be appreciated that this method scales effectively for deep networks, maintaining its performance advantages across multiple layers, since the weight matrices of each layer are stored in the same memory array and each layer takes just one cycle to be processed. This makes it particularly suitable for applications requiring real-time processing or those running on resource-constrained devices.

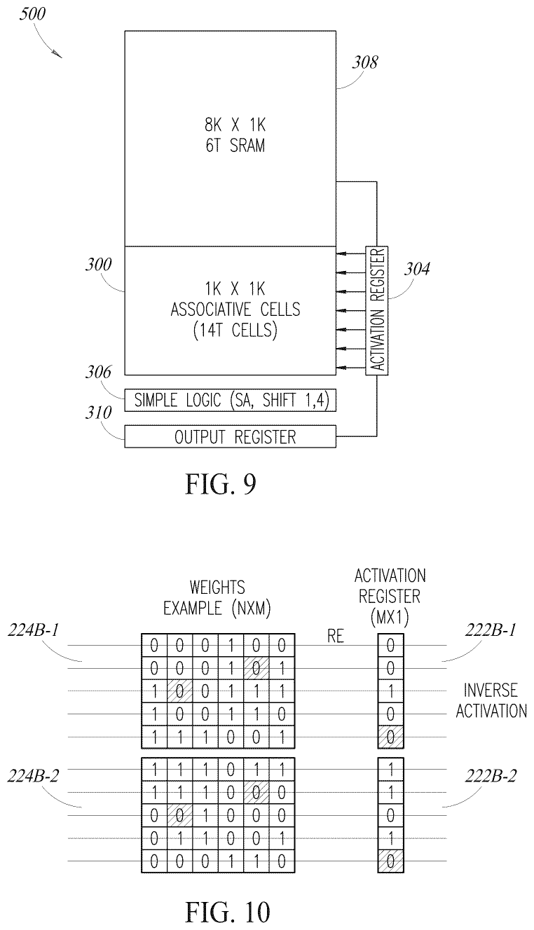

Reference is now made to FIG. 9, which may illustrate an alternative binary neural network implementation 500 using an associative processing unit for a convolution neural network (CNN) operating on images. Implementation 500 may include an 8K×1K 6T SRAM array 308 for storing the images to be processed, which may serve as “L1” storage. Below SRAM array 308, may be a 1K×1K memory array 300 of 14T SRAM cells, similar to the SRAM cells of FIG. 7, which may be referred here as the MMB (Memory Matrix Block). An activation register 304 may be positioned along the side of the associative cells array 300 to provide the input for processing.

Implementation 500 may include simple logic circuitry 306 positioned below the associative cells array 300, which may include shift and SA (sense amplifier) functionality, as well as a majority unit. An output register 310 may receive the final output from activation register 304. This architecture may be designed to process a batch of 4 images simultaneously, each quantized to −1 and +1 values and initially sized at 224×224 pixels. SRAM array 308 may store these initial images.

MMB 300 may be divided into 16 sections of 64 rows each, allowing parallel processing of 16 lines per image for all 4 images. A 3×3 convolution operator (not shown) may be operated on each image. Implementation 500 may use shift operations to flatten the 3×3 convolution operator for each pixel, aligning all nine convolution weights in one bit line (similar to that performed to generate weights 224A of FIG. 5A).

For the first layer, the controller of implementation 500 may load the 9 image bits from L1 into activation register 304 to generate the convolution in parallel in MMB 300. In one embodiment, the controller may load the 9 image bits from only half the bit lines of L1 308 to produce a 112×112 output. Subsequent layers may use progressively fewer bit lines of L1: ¼ for the 56×56 layer, and so on.

When reaching the 28×28 layer (i.e. having 28*28=784 bits), the system may flatten each 28×28 section of the image into one line of 784 bits and may duplicate it 64 times to generate 64 channels. This may be repeated for the 4 images, resulting in 256 bit lines in MMB 300. As each convolution may require a different resolution, the system may precharge only 4 bit lines of the 256 bit lines in MMB 300.

For layers from 224×224 to 56×56, the majority unit in logic 306 may operate in-section on ½ and ¼, respectively, of the bit lines. For layers from 28×28 to 7×7, the system may work on 8 bit lines at a time.

MMB 300 may be divided into 16 or 32 sections. For implementing a CNN, the controller may inhibit up to 9 RE rows per section for ½ and ¼ and maybe ⅛ of the bit lines.

It will be appreciated that implementation 500 may provide a very small form-factor, may operate with very low power and may have a high operations per word line ratio. Importantly, since the image data is stored in MMB 300 and the performance of each bit line per cycle is very high (i.e. each cycle provides a complete MAC calculation), the controller does not have to move or arrange the data in MMB 300 for different sizes of blocks for CNN, as the data remains in place in MMB 300. Even though very large images may be stored over multiple bit lines, they may be processed individually, since the performance of each bit line is so fast. This may significantly simplify any compilers written to work with implementation 500.

Reference is now made to FIG. 10, which may illustrate an exemplary weights matrix with corresponding activation register values, demonstrating how ternary values may be represented and handled in the present invention, using the example of FIG. 6.

As in FIG. 6, weights matrix 224 may be divided into a weight section 224a and an inverse weight section 224b, and activation register 222 may be divided into an activation section 222a and an inverse activation section 222b.

The data stored in both weights matrix 224 and activation register 222 may represent ternary weights using a binary encoding scheme. In this scheme, a ternary value of +1 may be represented by [1,0], a ternary value of −1 may be represented by [0,1], and a ternary value of 0 may be represented by [0,0]. FIG. 10 shows some weight values represented as slashed 0 bits in both the positive and inverse sections of both weights matrix 224 and activation register 222. These slashed 0 bits indicate ternary 0 values, since they have 0 values in both versions of the data.

It will be appreciated that implementation 500 may be utilized for multiple types of neural networks, such as convolution neural networks (CNNs), deep neural networks (DNNs), binary networks (BNNs), large language models (LLMs), etc.

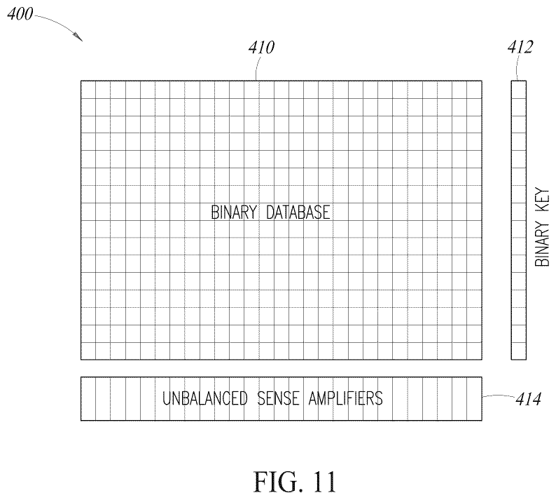

In addition, as shown in FIG. 11 to which reference is now made, the present invention may be implemented for binary neural search, such as a Hamming search. A search system 400 may comprise an associative memory array 410, having memory array 300 and storing one item of a binary database to be searched in each column. Search system 400 may also comprise unbalanced sense amplifiers as its majority unit 414 and a binary key unit 412 as its activation unit.

Binary key unit 412 may be configured to receive a search term or criteria for the binary search operation and may activate all binary vectors in the binary database, stored in associative memory array 410, in parallel, according to the search term or criteria in binary key unit 412. When activating the rows, the binary key may be XOR'd in parallel against all the binary vectors stored in the memory array, in a single cycle. Such a XOR operation may be implemented as part of a Hamming search.

It will be appreciated that the search results may be provided in a single cycle! Moreover, since each unbalanced sense amplifier outputs a 1 (indicating a match) only if the number of 1 values on a bit line are significantly lower than the number of 0 values (i.e. below a predetermined threshold number), there may be relatively few (i.e. only K) matched values and thus, these matched values may represent a “top K” search result, all in a single cycle.

It will also be appreciated that a sensitivity of the unbalanced sense amplifier may be programmed, to provide a different number of results (i.e. in order to change “K”). This approach may be particularly beneficial for applications requiring rapid search and retrieval of binary data.

Applicant has realized that the majority systems described hereinabove may be used for other purposes, such as for voting and for counting.

For example, there are many cases where the majority may need to have a significant credibility to get better performance. For example, a majority of more than 70% (i.e. over 70% of the values are either 1 or −1) values) may be of interest. Any values of less than this may be ignored and marked with a 0 value.

To implement this type of majority, dummy bits may be added to the activation vector. For example, suppose we have a majority of 1 for 24 selected cells (in a section capable of processing up to 32 cells). On a next cycle 4 dummy bits (i.e. logical 0s but implemented as −1 values) may be added to the activation vector and the calculation may be redone. In this second cycle, the check may be that whether there is a majority of 28 bits, and if it is still “1”, then this result of 1 has a high credibility; if, on the other hand, the majority value changes to −1, it indicates low credibility and the majority result is marked as a “0”.

Each dummy bit may be implemented by activating both the read enable (RE) and the read enable bar (REb) with a 0 value.

In a further example, there are many cases where the size of majority may need to be determined. Such a majority may be counted (i.e. the exact number of 1's may be determined) by adding or deleting dummy bits using a “successive approximation” that will take log 2(N) steps, where N is the number of majority cells.

For example, if there are N=16 bits to find a majority in, and the initial search found that there is a majority (i.e. the result was a 1 value). We can find how many ones there were with the following procedure:
1) Initially add 16 Dummy “0”'s to the majority search and check the resultant majority of the 32 cells. If no majority is found (i.e. the number of 0's=the number of 1's), then the count is 16. If not (i.e. the majority result changed to 0), go to the next step.
2) Check the original 16 bits with an additional 16/2=8 dummy 0's (i.e. giving a total of 24 bits). If the majority changes back to 1, go to the next step. If no majority is found, then we know that for 24 cells, the number of O's equals the number of 1's, so the number of bits with a 1 value is 12.
3) Repeat steps 1 and 2 with different amounts of additional dummy 0's until there is no change.

Since each step occurs in a single cycle, this majority counting is very fast and thus may be utilized in many systems where a fast count is needed. For example, it may be used in a Hamming search as it is faster than the prior art methods of counting Hamming search results.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. An in-memory, one cycle, binary multiplier comprising:
a memory array having rows and columns and storing a weights matrix of binary weights therein;
an input unit receiving a binary activation vector, said input unit to activate rows of said weight matrix according to said binary activation vector; and
a plurality of majority sense amplifiers, one per column of said weights matrix, each said majority sense amplifier generating a majority function of the multiplication of said binary weights in its column by said binary activation vector.

2. The binary multiplier of claim 1 wherein said weights matrix comprises a positive section and an inverse section storing said binary weights and inverses of said binary weights respectively, and said binary activation vector comprises a positive portion and an inverse portion storing binary activations and inverses of said binary activations, respectively, wherein columns of said positive section are aligned with columns of said inverse section and wherein said input unit to activate rows of said positive section according to said positive portion and rows of said inverse section according to said inverse portion.

3. The binary multiplier of claim 1, wherein said memory array comprises:
a plurality of SRAM cells each storing a binary weight, wherein each said SRAM cell is activatable by a positive word line and an inverse word line and provides results of a binary multiplication of said binary weight with a positive word line value on a positive bit line and results of a binary multiplication of said binary weight with an inverse word line value on an inverse bit line; and
a plurality of per-column majority units to determine a majority value of the positive and inverse outputs of a column of said plurality of SRAM cells.

4. The binary multiplier of claim 1, wherein said per-column majority units are differential sense amplifiers.

5. The binary multiplier of claim 1, wherein:
said weights matrix stores ternary weights encoded using pairs of binary bits, wherein a ternary value of +1 is represented by [1,0], a ternary value of −1 is represented by [0,1], and a ternary value of 0 is represented by [0,0];
said binary activation vector comprises ternary activation values encoded using pairs of binary bits;
said input unit is configured to activate rows of said weight matrix according to said ternary activation values; and
each said majority sense amplifier is configured to generate a majority function of the multiplication of said ternary weights in its column by said ternary activation vector.

6. The binary multiplier of claim 1, and also comprising a controller configured to:
provide an initial binary activation vector to said input unit to generate an initial majority result using the plurality of majority sense amplifiers;
modify the binary activation vector by adding or removing one or more bits;
provide the modified binary activation vector to said input unit to generate a subsequent majority result using the plurality of majority sense amplifiers;
compare the initial majority result with the subsequent majority result; and
determine a characteristic of the majority vote based on the comparison.

7. The binary multiplier of claim 1, and also comprising a controller configured to:
provide an initial binary activation vector to said input unit to generate an initial majority result using the plurality of majority sense amplifiers;
iteratively modify the binary activation vector by adding or removing a predetermined number of bits;
provide each modified binary activation vector to said input unit to generate subsequent majority results using the plurality of majority sense amplifiers;
compare each subsequent majority result with previous majority results; and
determine a count of activated bits in the initial binary activation vector based on the comparisons.

8. A system for implementing a multi-layer neural network, the system comprising:
a memory array comprising a plurality of columns, each column storing a plurality of binary weights and having a bit line processor;
an activation register configured to store activation values;
a controller configured to iteratively, for each layer of the neural network:
activate multiple rows of the memory array according to a vector of binary activation values for a current cycle to multiply columns of said memory array by said vector of binary activation values;
in per-column majority sense amplifiers corresponding to a subset of columns of the memory array corresponding to weights between a current layer and a next layer, output per-column majority values for said subset of columns, as the values for said next layer;
update the activation register with the generated output values for use as activation values in processing a next layer in a next cycle; and
an output register configured to receive output values generated for a final layer of said multi-layer neural network.

9. The system of claim 8, wherein said per-column majority sense amplifiers are differential sense amplifiers.

10. The system of claim 8, wherein said memory array comprises:
a plurality of SRAM cells each storing a binary weight, wherein each said SRAM cell is activatable by a positive word line and an inverse word line and provides results of a binary multiplication of said binary weight with a positive word line value on a positive bit line and results of a binary multiplication of said binary weight with an inverse word line value on an inverse bit line.

11. The system of claim 10, wherein the system is configured to implement a convolutional neural network (CNN) and also comprises a storage memory array to store image data and to provide an operatable portion of said image data to said activation register.

12. A binary neural search system comprising:
a memory array comprising a plurality of columns, each column storing a binary vector of a binary database;
a binary key unit configured to receive a binary search term;
a plurality of unbalanced sense amplifiers, each unbalanced sense amplifier corresponding to a column of the memory array; and
a controller configured to:
activate multiple rows of said memory array according to said binary search term, thereby causing a parallel match operation between the search term and each binary vector stored in said columns of the memory array; and
determine, from the output of the unbalanced sense amplifiers, matches between the search term and one or more binary vectors in the binary database based on a number of matching bits for said one or more binary vectors, wherein each unbalanced sense amplifier is configured to output a match indication only when the number of matching bits in its corresponding column exceeds a predetermined threshold.
